(19) United States
(12) Patent Application Publication
(10) Pub. No.: US 2010/0028212 A1
(43) Pub. Date: Feb. 4, 2010

(54) SAMPLE ANALYZER FOR TRACE DETECTING DEVICE

(76) Inventors: Wen He, Beijing (CN); Yangtian Zhang, Beijing (CN); Hua Peng, Beijing (CN)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/512,435

(22) Filed: Jul. 30, 2009

(30) Foreign Application Priority Data
Aug. 4, 2008 (CN) 200810117699.4

(51) Int. Cl. B01L 7/00

(52) U.S. Cl. 422/99

(57) ABSTRACT

The present invention discloses a sample analyzer comprising a heater and a sample feeding carrier, wherein the heater and the sample feeding carrier are integrally formed, such that the positional relation between the sample feeding carrier and the heater is fixed. Compared with the prior art, since the heater and the sample feeding carrier of present invention is formed integrally, the positional relation between the sample feeding carrier and the heater is fixed, accordingly, the consistency in heating-up of the sample is enhanced. Moreover, because the sample feeding carrier and the heater are made of low capacity material, the change of the temperature is rapid during the heating process, as a consequence, the analyzer consumes less power and could achieve a rapid temperature control.

### CROSS-REFERENCE TO RELATED APPLICATION

The present application claims priority of Chinese patent application Serial No. 200810117699.4, filed Aug. 4, 2008, the content of which is hereby incorporated by reference in its entirety.

### FIELD OF THE INVENTION

The present invention relates to a sample analyzer for a trace detecting device.

### DESCRIPTION OF RELATED ART

In a trace detecting device, a sample analyzer includes a heater and a sample feeding carrier. Conventionally, the heater and the sample feeding carrier is provided separately and independently, that is, the heater is fixed in the interior of the trace detecting device, and the sample feeding carrier carrying the sample needs to be transferred to the heater. Due to the separate arrangement of the heater and the sample feeding carrier, the existing sample analyzer has following problems: the positional relation between the heater and the sample feeding carrier is not constant, sometimes the sample feeding carrier might deviate from the correct heating position of the heater, which decreases the consistency of the heating-up of the sample, for the heating effect will be affected by the environment and the manual operation.

Besides, conventional sample analyzer presents another problem: the thermal capacity of the heater is too large, which cause a slow variance in temperature when the heater is running; as a result, the conventional sample analyzer consumes more power and could not achieve a rapid temperature control on the other hand.

### SUMMARY OF INVENTION

The objective of present invention is to provide a sample analyzer with a high heating consistency.

To achieve above objective, present invention provides a sample analyzer, comprising a heater and a sample feeding carrier, wherein the heater and the sample feeding analyzer is integrally formed, such that the positional relation between the sample feeding carrier and the heater is fixed.

Further, the sample feeding carrier and the heater is made of material with low thermal capacity.

In addition, the present invention also provide a trace detecting device including a sample analyzer, wherein the sample analyzer comprises a heater and a sample feeding carrier which are integrally formed, such that the positional relation between the sample feeding carrier and the heater is fixed.

Compared with the prior art, since the heater and the sample feeding carrier of present invention is formed integrally, the positional relation between the sample feeding carrier and the heater is fixed, accordingly, the consistency in heating-up of the sample is enhanced. Moreover, because the sample feeding carrier and the heater are made of low capacity material, the change of the temperature is rapid during the heating process, as a consequence, the analyzer consumes less power and could achieve a rapid temperature control.

### BRIEF DESCRIPTION OF THE DRAWINGS

FIG. 1 is a schematic view illustrating the structure of a first embodiment of the sample analyzer according to the present invention.

FIG. 2 is a schematic view illustrating the structure of a second embodiment of the sample analyzer according to the present invention.

FIG. 3 is a schematic view illustrating the structure of a third embodiment of the sample analyzer according to the present invention.

### DETAILED DESCRIPTION OF THE INVENTION

The embodiment of present invention would be described with reference to the attached figures.

### 1^{st} Embodiment

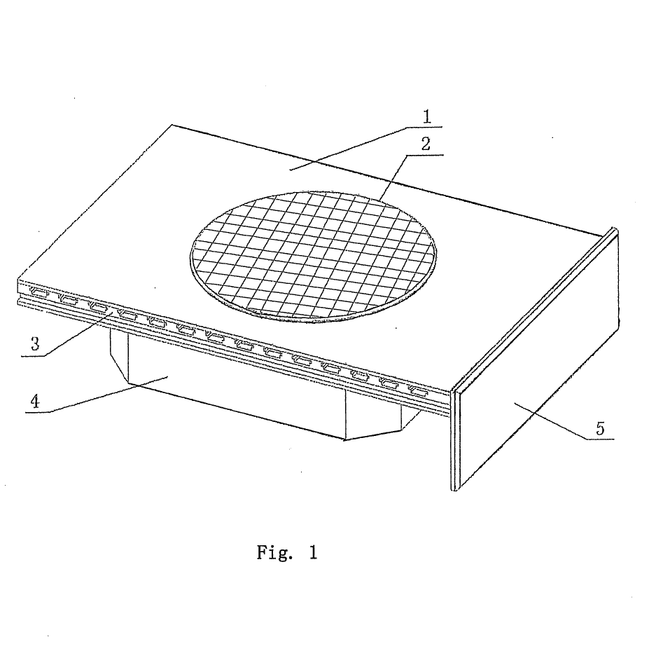

Referring to FIG. 1, which schematically illustrates the structure of a first embodiment of the sample analyzer according to the present invention. As seen from FIG. 1, the sample analyzer comprises a heater and a sample feeding carrier 2, the heater comprises an upper surface 1 and a lower surface therebetween a plurality of heating elements 3 are disposed. The sample feeding carrier 2 is disposed fixedly on the upper surface 1 of the heater, so that the heater and the sample feeding carrier 2 form an integral part, which causes the positional relation between the sample feeding carrier 2 and the heater to be invariable.

Preferably, the sample feeding carrier is a meshwork 2 disposed in an opening in the upper surface of the heater, said opening corresponds to the shape of the meshwork 2. By such arrangement, the positional relation between the heating element 3 and the meshwork 2 is fixed, and because the heating element 3 is disposed directly below the meshwork 2, the heating element 3 could heat the sample directly through the meshwork 2.

Preferable, the heating element 3 and the meshwork 2 is made of a low thermal capacity material, such as, aluminum, iron and other metal, or any other suitable material with low thermal capacity, so that the temperature of the heating element and the meshwork can change fast in the course of heating, with less power consumption and a prompt control on temperature variance.

Preferably, the sample analyzer further comprises a cooling fan 4 disposed on the lower surface of the heater, the cooling fan 4 cools the sample analyzer during transfer of the sample so as to quicken the cooling rate. Certainly, a natural cooling is also possible, which then needn't a cooling fan.

Preferably, the sample analyzer further comprises a baffle 5 disposed at the outer end of the sample analyzer, when the sample analyzer is inserted into the trace detecting device, the baffle 5 seals off the sample analyzer in the trace detecting device so as to prevent a heat loss and dust from coming into the analyzer.

### 2nd Embodiment

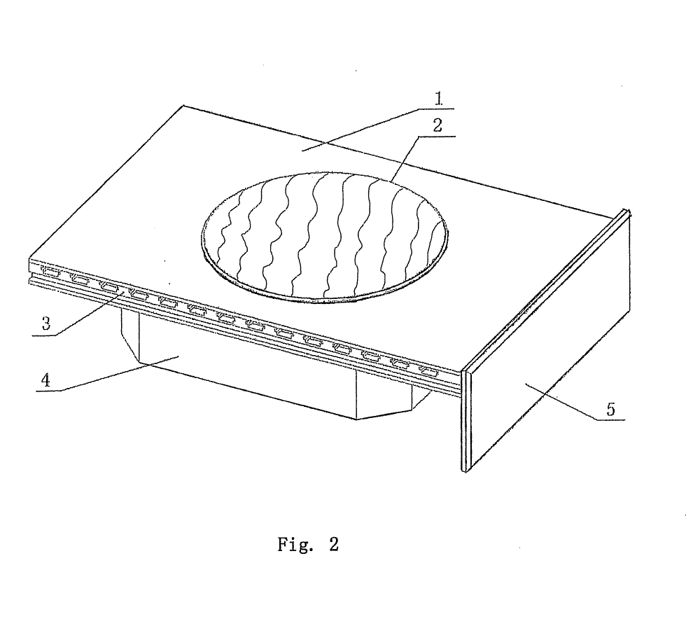

FIG. 2 is a schematic view illustrating the structure of a second embodiment of the sample analyzer according to the present invention. As seen from FIG. 2, except the sample feeding carrier 2 which is a pleat-like part instead of a meshwork, other components in the second embodiment of the sample analyzer are substantially same with that in first embodiment. There is a merit in using a pleat-like part as the carrier, that is, the increased heating area and the enhanced rate of thermal analysis of the sample.

### 3^{rd} Embodiment

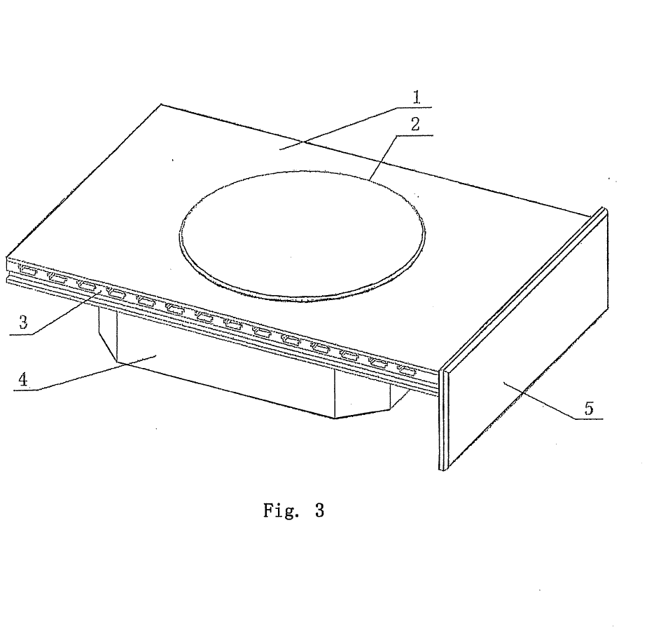

FIG. 3 is a schematic view illustrating the structure of a third embodiment of the sample analyzer according to the present invention. As seen from FIG. 3, the sample feeding carrier 2 is a flat panel rather than a meshwork, and other components in the third embodiment of the sample analyzer are substantially same with that in first embodiment. The merit of the third embodiment is simple in manufacturing.

Although the embodiments of present invention have been illustrated and described as above, those skilled in the art will appreciate that modifications may be made to these embodiments without departing from the principle and spirit of present invention, and the scope of the present invention is limited solely by the appended claims and its equivalents.

What is claimed is:

1. A sample analyzer, comprising a heater and a sample feeding carrier, characterized in that, the heater and the sample feeding carrier is integrally formed, such that the positional relation between the sample feeding carrier and the heater is fixed.

2. The sample analyzer according to claim 1, wherein the sample feeding carrier is a meshwork.

3. The sample analyzer according to claim 2, wherein the heater comprises a heating element distributed beneath the meshwork, and the positional relation between the heating element and the meshwork is fixed.

4. The sample analyzer according to claim 3, wherein the heating element and the meshwork is made of material with a low thermal capacity.

5. The sample analyzer according to claim 4, further comprising a cooling fan disposed below the heating element to cool the sample analyzer as required.

6. The sample analyzer according to claim 1, wherein the sample feeding carrier is a flat panel or a pleat-like part.

7. The sample analyzer according to claim 5, further comprising a baffle disposed at the outer end of the sample analyzer.
